(19) United States
(12) Patent Application Publication
(10) Pub. No.: US 2007/0294703 A1
(43) Pub. Date: Dec. 20, 2007

(54) System and Method for Migration of Information From a Legacy to a Replacement Information Handling System

(76) Inventors: Ozan Talu, Cedar Park, TX (US); Christopher Speers, Austin, TX (US)

Correspondence Address: HAMILTON & TERRILE, LLP, P.O. BOX 203518, AUSTIN, TX, 78720, US

(21) Appl. No.: 11/424,896

(22) Filed: Jun. 19, 2006

(51) Int. Cl. G06F 9/46

(52) U.S. Cl. 719/310

(57) ABSTRACT

Migration of user information from a legacy information handling system to a replacement information handling system, including user operating system configuration settings, is performed by copying an image of a legacy hard disk drive to a replacement hard disk drive. Legacy hardware drivers are removed from the image copied to the replacement hard disk drive and replacement hardware drivers are inserted into the image copied to the replacement hard disk drive. The replacement information handling system is booted from an operating system of the image copied to the replacement hard disk drive so that the image operating system can activate the replacement hardware drivers, such as with plug and play functionality. The replacement information handling system then presents the operating environment of the legacy information with the user information copied with the image.

### BACKGROUND OF THE INVENTION

1. Field of the Invention

The present invention relates in general to the field of information handling system information migration, and more particularly to a system and method for migration of information from a legacy to a replacement information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have become central to the organization of business and personal affairs. End users often maintain critical information used in daily affairs on their information handling system, like contact information, such as address books, financial information, such as spreadsheets, and work product, such as word processing documents. In order to ready, update and create these types of critical information, information handling systems generally have specific applications preinstalled that handle the various types of files, such as word processing files and documents, e-mail, and client applications that manage e-mail. Typically end users will configure their information handling systems to optimize personal efficiency, such as with settings that define application functions and desktop presentation. Periodically, end users replace their information handling systems with new systems having more powerful and reliable components. For instance, after several years in use, a replacement information handling system will typically offer a more powerful processor, increased RAM, greater hard disk drive storage and improved bus speeds. However, replacing a legacy information handling system with a new system often presents a hassle to the end user because the end user typically wants to copy personal information from the legacy information handling system to the replacement information handling system. Further, after the legacy information is copied to the replacement information handling system, the user also often has to adjust the configuration settings of the replacement information handling system to those of the legacy information handling system. Additionally, the applications needed to manage, create, read and change the critical end user information must be reinstalled to the replacement information handling system.

In order to improve the transition from a legacy information handling system to a replacement information handling system, a variety of data migration applications are available. Generally, the replacement information handling system is first prepared with a clean operating system or enterprise image. Next, the replacement information handling system has end-user specific applications installed. Once the replacement information handling system has the operating system and applications loaded, user data and configuration settings are transferred from the legacy information handling system to the replacement information handling system. The migration of user data and configuration settings is usually performed with a crossover cable or through temporary network storage. Data migration in this manner takes a significant amount of upfront planning and advanced technical skills to ensure that all user data, applications and the look and feel of the legacy information handling system are available in the replacement information handling system's operating environment. Although operating systems typically support off line manipulation of a file system to adjust configuration settings, such as by copying registry files, accurately re-creating the operating environment of a legacy information handling system in a replacement information handling system is difficult to accomplish.

### SUMMARY OF THE INVENTION

Therefore a need has arisen for a system and method which simplifies migration from a legacy information handling system to a replacement information handling system of an existing look and feel, such as a legacy operating system, applications, information and end user settings, to more accurately recreate the legacy operating environment in the replacement information handling system.

In accordance with the present invention, a system and method are provided which substantially reduce the disadvantages and problems associated with previous methods and systems for migrating user data from a legacy information handling system to a replacement information handling system. An image of the legacy information handling system is copied to the replacement information handling system, including user information such as configuration settings. The legacy image operating system is manipulated to remove hardware support for legacy information handling system hardware components and insert hardware support for replacement information handling system hardware components, thus recreating the legacy operating environment with the replacement hardware platform.

More specifically, a migration agent running on a RAM disk defined in the legacy information handling system and the replacement information handling system coordinates the copying of an image of the legacy hard disk drive to the replacement hard disk drive. Cloning the legacy image to the replacement information handling system transfers all of the user data stored by the user on the legacy hard disk drive and the operating system, applications and user settings that runs the legacy information handling system. However, the operating system of the legacy image has hardware support for legacy hardware components rather than replacement hardware components. To adjust the operating system at the replacement information handling system, the migration agent runs on a migration operating system in a RAM disk of RAM of the replacement information handling system. Automated scripts of the migration agent identify legacy hardware support, remove the legacy hardware support from the image that was copied to the replacement information handling system, and insert hardware support for the hardware components of the replacement information handling system. The replacement information handling system is then booted to the image operating system to complete initiation of the hardware components, such as with plug and play operating system functionality.

The present invention provides a number of important technical advantages. One example of an important technical advantage is that an image of the legacy information handling system is copied to the replacement information handling system to more accurately replicate the legacy operating environment in the replacement information handling system. The end user environment is essentially moved from the legacy information handling system to a replacement information handling system that has an incompatible hardware platform. Off line manipulation of the operating system file system at the replacement information handling system eliminates hardware settings of the legacy information handling system, establishes hardware settings of the replacement information handling system and allows boot of the replacement information handling system to the legacy operating environment without selectively adjusting end user data or configuration settings or separately determining the applications that existed on the legacy system that need reinstallation on the replacement system. This simplifies the data migration process and improves end user satisfaction with the replacement information handling system, which is ready for use with the legacy operating environment.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for migrating user information from a legacy information handling system to a replacement information handling system; and

FIG. 2 depicts a flow diagram of a process for migrating user information from a legacy information handling system to a replacement information handling system.

### DETAILED DESCRIPTION

Migration of an image of a legacy information handling system to a replacement information handling system provides the legacy operating environment on the replacement information handling system. The migration adjusts the image for variations in the hardware components of the replacement information handling system from the hardware components of the legacy information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

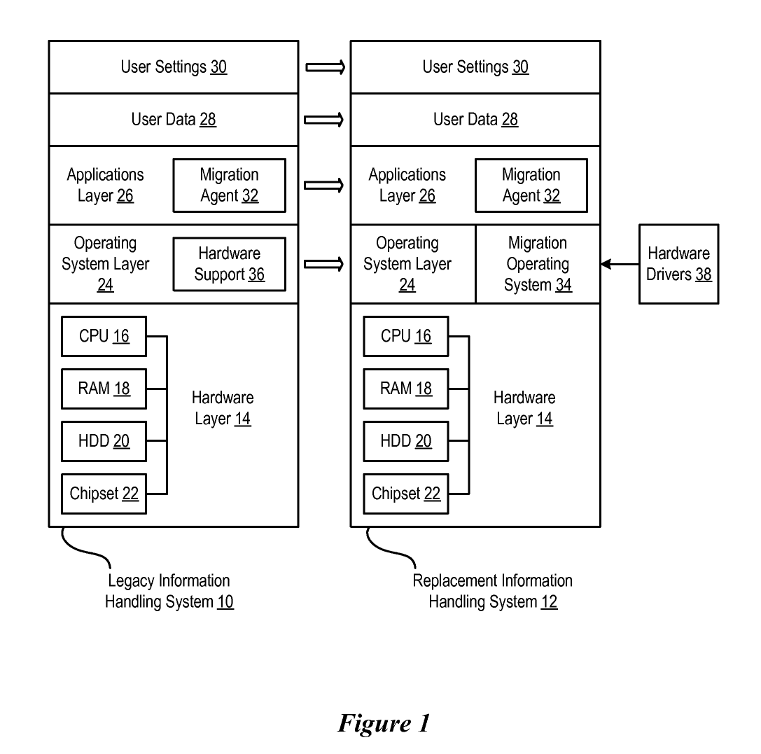

Referring now to FIG. 1, a block diagram depicts a system for migrating user information from a legacy information handling system 10 to a replacement information handling system 12. Both legacy information handling system 10 and replacement information handling system 12 include plural processing components in a hardware layer 14 for processing information, such as a CPU 16, RAM 18, a hard disk drive 20 and a chipset 22. However, some or all of the processing components of legacy information handling system 10 differ from the processing components of replacement information handling system 12 so that the hardware drivers loaded on legacy information handling system 10 would not work properly on replacement information handling system 12. This hardware device dependence prevents direct transfer of the contents of legacy information handling system 10 to replacement information handling system 12. Thus, conventional image migration first builds an independent image on replacement information handling system 12 and then populates the newly built image with user information gleaned from legacy information handling system 10. In contrast, the present invention migrates all information content from the legacy information handling system 10 to the replacement information handling system 12 and adjusts the hardware drivers of the migrated content to adapt to the hardware components of the replacement information handling system 12.

Above hardware layer 14, an operating system layer 24 includes an operating system, such as WINDOWS, that coordinates operation of the processing components with applications of an application layer 26. A user data layer 28 includes user-stored information, such as documents and spread sheets that were created with applications of application layer 26. A user settings layer 30 includes user configuration settings that define defaults for the applications and operating system, such as for the presentation of a desktop. Operating system layer 24, application layer 26, user data 28 and user settings 30 are stored in permanent storage, such as hard disk drive 20 and retrieved to RAM for use during operation of the information handling system. In order to migrate an existing operating environment of a legacy information handling system 10 to a replacement information handling system 12, a migration agent 32 copies an image of legacy information handling system 10 hard disk drive 20 to replacement information handling system 12 hard disk drive 20. The legacy hard disk drive image includes operating system layer 24, application layer 26, user data 28 and user settings 30, and is, for example copied with a conventional imaging tool such as GHOST. To free up hard disk drives 20 for the imaging process, migration agent 32 establishes a RAM drive in RAM 18 of each information handling system. Replacement information handling system 12 operates under the control of a migration operating system 34, such as WinPE, that boots from a removable media, such as a USB key or optical disc.

When the image of legacy information handling system 10 is initially copied to replacement information handling system 12, legacy hardware support 36 is included. Since legacy hardware support 36 will not work with replacement information handling system 12, migration agent 32 removes legacy hardware support 36 from the image copied to replacement information handling system 12 and instead inserts replacement hardware drivers 38 into the image copied onto replacement information handling system 12. The removal of legacy hardware support 36 and insertion of replacement hardware drivers 38 is performed with conventional operating system offline file system manipulation while replacement information handling system 12 operates under the control of migration operating system 34. An automatically executed script identifies and removes legacy hardware support 36. Another automatically executed script identifies the model type of replacement information handling system 12 and injects a set of replacement hardware drivers 38 associated with the identified model type. Once replacement hardware drivers 38 are inserted, replacement information handling system 12 is booted to the operating system provided with the legacy image so that the legacy operating system can activate replacement hardware drivers 38 through the plug and play process. After the hardware drivers are initiated and replacement information handling system 12 is operating under control of the legacy operating system with the legacy user data and configuration settings, migration agent 32 completes any additional maintenance steps, such as inventory of the replacement information handling system, operating system upgrades, diagnostics and other cleanup items. Replacement information handling system 12 is then ready for use with the legacy operating environment presented through the replacement processing components.

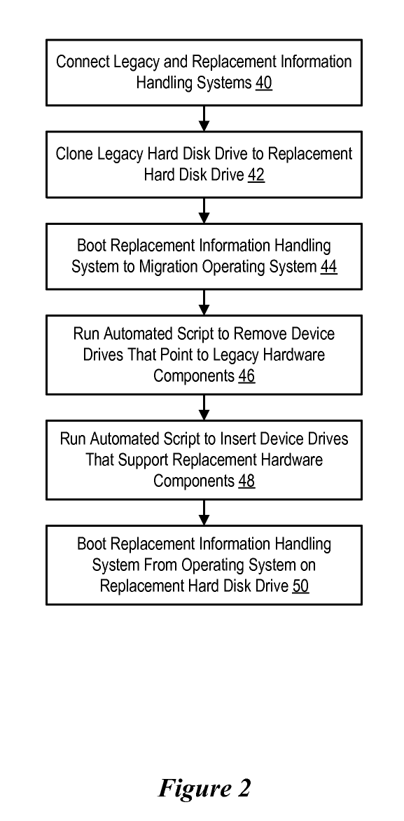

Referring now to FIG. 2, flow diagram depicts a process for migrating user information from a legacy information handling system to a replacement information handling system. The process begins at step 40 with the connection of the legacy information handling system and the replacement information handling system to support data transfer. For instance, the legacy and replacement information handling systems are directly connected with a crossover cable or IDE connection or indirectly connected through a network interface. At step 42, the contents of the legacy information handling system hard disk drive are cloned onto the replacement hard disk drive, such as with the GHOST imaging application. At step 44, the replacement information handling system is booted to a migration operating system, such as WinPE, that allows offline manipulation of the operating system copied with the legacy hard disk drive image. For instance, a RAM drive is established in RAM of the replacement information handling system to allow access to the legacy image. At step 46, an automated script is run on the replacement information handling system to remove hardware support, such as device drives, that point to hardware components of the legacy information handling system. At step 48, another automated script runs on the replacement information handling system to insert hardware support, such as low level mass storage device drivers, for the hardware components of the replacement information handling system. For example, the script identifies the replacement information handling system model type to select a set of drivers associated with the hardware platform of the model type and inserts the set of drivers into the operating system file system. With the replacement hardware support inserted in the legacy image, at step 50, booting the replacement information handling system installs the hardware support through operating system plug and play functionality. Once the hardware support activation is complete, additional automated scripts can perform a variety of maintenance functions, such as performing an asset inventory of the replacement information handling system, performing an operating system upgrade, performing diagnostics or performing other post-installation clean-up.

Although the present invention has been described in detail, it should be understood that various changes, substitutions and alterations can be made hereto without departing from the spirit and scope of the invention as defined by the appended claims.

What is claimed is:

1. A system for migrating user information from a legacy information handling system to a replacement information handling system, the system comprising:
one or more replacement hardware drivers operable to support operation of one or more hardware components associated with the replacement information handling system;
a migration operating system operable to support operation of the replacement information handling system; and
a migration agent operable to run on the replacement information handling system over the migration operating system, the migration agent further operable to copy an image of the legacy information handling system to the replacement information handling system, to remove legacy hardware drivers from the image copied to the replacement information handling system and to insert the replacement hardware drivers in the image copied to the replacement information handling system.

2. The system of claim 1 wherein the image comprises operating system user configuration settings.

3. The system of claim 1 wherein the migration operating system is further operable to boot to a RAM disk defined in RAM of the replacement information handling system.

4. The system of claim 1 wherein the migration agent comprises an automated script operable to identify and remove the legacy hardware drivers.

5. The system of claim 1 wherein the migration agent comprises an automated script operable to insert the replacement hardware drivers.

6. The system of claim 5 wherein the automated script inserts the replacement hardware drivers by:
identifying the replacement information handling system model type;
retrieving a set of hardware drivers associated with the identified model type; and
copying the retrieved set of hardware drivers to the replacement information handling system.

7. The system of claim 1 wherein the image copied to the replacement information handling system comprises an operating system operable to plug and play the replacement hardware drivers to operate the replacement information handling system.

8. The system of claim 7 wherein the migration agent is further operable to automatically perform one or more maintenance functions after boot of the image operating system.

9. The system of claim 8 wherein the maintenance functions comprise diagnostics of the replacement information handling system.

10. The system of claim 8 wherein the maintenance functions comprise one or more upgrades to the image operating system.

11. A method for migrating user information from a legacy information handling system to a replacement information handling system, the method comprising:
interfacing the legacy information handling system to the replacement information handling system;
copying an image of the legacy information handling system hard disk drive to the replacement information handling system hard disk drive;
removing legacy hardware drivers from the image copied to the replacement hard disk drive; and
inserting replacement hardware drivers into the image copied to the replacement hard disk drive.

12. The method of claim 11 further comprising:
booting the replacement information handling system from an operating system of the image copied to the replacement hard disk drive; and
activating the replacement hardware drivers through plug and play of the image operating system.

13. The method of claim 12 further comprising automatically performing one or maintenance functions after the activating of the replacement hardware drivers.

14. The method of claim 13 wherein the maintenance functions comprise an upgrade of the image operating system.

15. The method of claim 13 wherein the maintenance functions comprise diagnostics of the replacement information handling system.

16. The method of claim 11 wherein the image copied to the replacement information handling system comprises user information.

17. The method of claim 11 wherein the user information comprises user operating system configuration settings.

18. The method of claim 11 wherein copying an image of the legacy information handling system hard disk drive to the replacement information handling system hard disk drive further comprises running the replacement information handling system with a migration operating system running in a RAM disk defined in RAM of the replacement information handling system.

19. The method of claim 11 wherein interfacing the legacy information handling system to the replacement information handling system further comprises connecting the legacy information handling system to the replacement information handling system with a crossover cable.

20. The method of claim 11 wherein interfacing the legacy information handling system to the replacement information handling system further comprises establishing an interface through a network.
